(19) United States
(12) Patent Application Publication
(10) Pub. No.: US 2026/0323503 A1
(43) Pub. Date: Oct. 15, 2026

(54) INTEGRATING A SCHEDULED POWER SAVING SCHEME WITH A DYNAMIC POWER SAVING SCHEME IN WIRELESS NETWORKS

(71) Applicant: NEWRACOM, Inc., Irvine, CA (US)

(72) Inventors: Jaehyuk CHOI, Seongnam (KR); Joonsoo LEE, Irvine, CA (US)

(73) Assignee: NEWRACOM, Inc., Irvine, CA (US)

(21) Appl. No.: 19/641,195

(22) Filed: Apr. 7, 2026

Related U.S. Application Data
(60) Provisional application No. 63/786,122, filed on Apr. 9, 2025.

(51) Int. Cl. H04W 52/02; H04W 8/22; H04W 74/00; H04W 74/0816

(52) U.S. Cl. CPC H04W 52/0203; H04W 8/22; H04W 74/002; H04W 74/0816

(57) ABSTRACT

Disclosed herein is a method performed by a station (STA) to integrate a scheduled power saving scheme with a dynamic power saving scheme. The method includes the steps of operating in a high capability mode of the dynamic power saving scheme when a service period of the scheduled power saving scheme begins, during the service period, transitioning from operating in the high capability mode to operating in a low capability mode of the dynamic power saving scheme in response to determining that a predefined condition has been satisfied, and entering a doze state when the service period ends.

### CROSS-REFERENCE TO RELATED APPLICATION

This application claims the benefit of U.S. Provisional Application No. 63/786,122, filed Apr. 9, 2025, titled “Systems and Methods for Coordinating Long-Term and Short-Term Power Saving Modes in IEEE 802.11 Networks”, which is hereby incorporated by reference.

### TECHNICAL FIELD

The present disclosure generally relates to wireless communications, and more specifically, relates to integrating a scheduled power saving scheme with a dynamic power saving scheme in wireless networks.

### BACKGROUND

Institute of Electrical and Electronics Engineers (IEEE) 802.11 is a set of standards for implementing wireless local area network communication in various frequencies, including but not limited to the 2.4 gigahertz (GHz), 5 GHz, 6 GHz, and 60 GHz bands. These standards define the protocols that enable Wi-Fi devices to communicate with each other. The IEEE 802.11 family of standards has evolved over time to accommodate higher data rates, improved security, and better performance in different environments. Some of the most widely used standards include 802.11a, 802.11b, 802.11g, 802.11n, 802.11ac, and 802.11ax (also known as “Wi-Fi 6”). These standards specify the modulation techniques, channel bandwidths, and other technical aspects that facilitate interoperability between devices from various manufacturers. IEEE 802.11 has played an important role in the widespread adoption of wireless networking in homes, offices, and public spaces, enabling users to connect their devices to the internet and each other without the need for wired connections.

Target wake time (TWT) is a power-saving feature that was introduced in the IEEE 802.11ah wireless networking standard and has been actively utilized in the IEEE 802.11ax (Wi-Fi 6) wireless networking standard and subsequent wireless networking standards to improve energy efficiency in Wi-Fi networks. By allowing an access point (AP) and a station (STA) to negotiate predefined wake-up schedules, TWT can significantly reduce power consumption and improve battery life for devices, particularly for Internet of Things (IoT) and mobile applications. The scheduled wake-up times allow STAs to avoid unnecessary contention and remain in a low-power state when data transmission is not required, leading to optimized channel utilization, reduced latency, and improved network efficiency.

Existing TWT mechanisms operate under the assumption that a STA remains fully awake and functions at maximum capacity throughout the minimum TWT wake duration within a TWT service period (SP). However, with the evolution of next-generation Wi-Fi systems (e.g., the IEEE 802.11bn wireless networking standard (also referred to as Ultra High Reliability (UHR)), this assumption may no longer be valid due to the introduction of the dynamic power save (DPS) feature. DPS is a feature that allows a device to dynamically transition between a high capability mode and a low capability mode. When operating in the high-capability mode, the device can fully transmit and receive data. When operating in the low capability mode, the device is technically awake but minimizes transmissions to conserve power.

### BRIEF DESCRIPTION OF THE DRAWINGS

The disclosure will be more fully understood from the detailed description provided below and the accompanying drawings that depict various embodiments of the disclosure. However, these drawings should not be interpreted as limiting the disclosure to the specific embodiments shown; they are provided for explanation and understanding only.

FIG. 1 illustrates an example of a wireless local area network (WLAN) with a basic service set (BSS) that includes multiple wireless devices, in accordance with some embodiments of the present disclosure.

FIG. 2 is a schematic diagram of a wireless device, in accordance with some embodiments of the present disclosure.

FIG. 3A illustrates components of a wireless device configured to transmit data, in accordance with some embodiments of the present disclosure.

FIG. 3B illustrates components of a wireless device configured to receive data, in accordance with some embodiments of the present disclosure.

FIG. 4 illustrates interframe space (IFS) relationships, in accordance with some embodiments of the present disclosure.

FIG. 5 illustrates a Carrier Sense Multiple Access with Collision Avoidance (CSMA/CA)-based frame transmission procedure, in accordance with some embodiments of the present disclosure.

FIG. 6 illustrates maximum physical layer (PHY) rates for Institute of Electrical and Electronics Engineers (IEEE) 802.11 standards, in accordance with some embodiments of the present disclosure.

FIG. 7 provides a detailed description of fields in Extremely High Throughput (EHT) Physical Protocol Data Unit (PPDU) frames, including their purposes and characteristics, in accordance with some embodiments of the present disclosure.

FIG. 8 illustrates an example of multi-user (MU) transmission in Orthogonal Frequency-Division Multiple Access (OFDMA), in accordance with some embodiments of the present disclosure.

FIG. 9 illustrates an example of an access point sending a trigger frame to multiple associated stations and receiving Uplink Orthogonal Frequency-Division Multiple Access Trigger-Based Physical Protocol Data Units (UL OFDMA TB PPDUs) in response, in accordance with some embodiments of the present disclosure.

FIG. 10 is a diagram showing a wireless network environment that can implement a unified framework that integrates dynamic power save (DPS) features and target wake time (TWT) features, according to some embodiments.

FIG. 11 is a diagram showing frame exchange sequences for uplink (UL) and downlink (DL) communications with and without using TWT, according to some embodiments.

FIG. 12 is a diagram showing a TWT negotiation process, according to some embodiments.

FIG. 13 is a diagram showing TWT element format for specifying a wake interval and minimum wake duration, according to some embodiments.

FIG. 14 is a diagram showing details of a request type field of a TWT element, according to some embodiments.

FIG. 15 is a diagram showing DPS operations, according to some embodiments.

FIG. 16 is a diagram showing three service period (SP) types that integrate DPS features, according to some embodiments.

FIG. 17 is a diagram showing a frame exchange sequence for implementing a unified framework that integrates DPS features and TWT features, according to some embodiments.

FIG. 18 is a diagram showing a table describing different types of SPs, according to some embodiments.

FIG. 19 is a diagram showing a format of a control field of a TWT element, according to some embodiments.

FIG. 20 is a flow diagram of a method for integrating a dynamic power saving scheme with a scheduled power saving scheme, according to some embodiments.

FIG. 21 is a flow diagram of a method for negotiating a service period type, according to some embodiments.

### DETAILED DESCRIPTION

The present disclosure generally relates to wireless communications, and more specifically, relates to integrating a scheduled power saving scheme with a dynamic power saving scheme in wireless networks.

As mentioned earlier herein, existing target wake time (TWT) mechanisms operate under the assumption that a station (STA) remains fully awake and functions at maximum capacity throughout the minimum TWT wake duration within a TWT service period (SP). However, with the evolution of next-generation Wi-Fi systems (e.g., the IEEE 802.11bn wireless networking standard (also referred to as Ultra High Reliability (UHR)), this assumption may no longer be valid due to the introduction of the dynamic power save (DPS) feature.

The existing TWT framework does not account for dynamic power adaptations, which can result in inefficient channel utilization and energy consumption. Existing power-saving approaches primarily focus on optimizing DPS-related signaling mechanisms, enhancing mode-switching efficiency, and minimizing overhead during mode transitions. However, there is currently no unified framework that integrates DPS and TWT features to fully exploit the advantages of both features. The lack of coordination between DPS and TWT can result in inefficient SP scheduling and mode transitions, which can limit the potential gains in energy efficiency and channel utilization in next-generation wireless networks.

The present disclosure describes a unified framework that integrates a short-term/dynamic power saving scheme (e.g., DPS) with a long-term/scheduled power saving scheme (e.g., TWT). In an embodiment, the unified framework defines and supports various SP types that leverage DPS features in different ways and allows an AP and a STA to negotiate which SP type to use depending on their needs/requirements. Thus, the unified framework allows the AP and STA to choose the appropriate power management strategy that suits their needs.

As used herein, a scheduled power saving scheme is a type of scheme that enables devices to transition between an awake state and a doze state according to a predefined or negotiated schedule (e.g., having scheduled wake-up times and wake durations). TWT is an example of a scheduled power saving scheme. As used herein, a dynamic power saving scheme is a type of scheme that allows devices to switch between different power consumption modes (e.g., between a high capability mode and a low capability mode) on demand (e.g., via signaling). DPS is an example of a dynamic power saving scheme.

In an embodiment, the unified framework defines and supports three SP types: 1) a high-capability-only (HC-only) SP type; 2) a DPS-allowed SP type; and 3) a hybrid SP type. With the HC-only SP type, a STA that is a member of the SP operates in the high capability (HC) mode for the entire TWT wake duration of the SP similar to traditional DPS-disabled STAs. This SP type has low control frame exchange overhead and may enable low latency communication. With the DPS-allowed SP type, a STA that is a member of the SP initially operates in the low capability (LC) mode at the beginning of the SP and only transitions to operating in the HC mode when triggered by the AP. This SP type leverages DPS features to reduce power consumption while maintaining scheduled communication, if needed. With the hybrid SP type, a STA that is a member of the SP initially operates in the HC mode at the beginning of the SP and transitions to operating in the LC mode when a predefined condition has been satisfied (e.g., after a minimum TWT wake duration expires or when a SP early termination event occurs). This type of SP allows for low latency and high throughput communication while also allowing potential extensions of active communication beyond the minimum TWT wake duration or other conditions such as SP early termination by having the STA remain operate in the LC mode instead of entering the doze state.

The unified framework enables seamless coordination between a long-term/scheduled power saving scheme such as TWT and a short-term/dynamic power saving scheme such as DPS to support diverse power-saving and performance requirements across a range of devices and traffic patterns. The unified framework may allow for controlling power-saving behavior on a per-SP basis through the explicit negotiation of SP types (e.g., HC-only, DPS-allowed, and hybrid), which can provide adaptability and operational efficiency.

The unified framework may make use of existing signaling structures (e.g., a TWT element) to negotiate or indicate the SP type of upcoming SPs. In an embodiment, the unified framework leverages two bits within a reserved field of the TWT control field to specify the SP type of upcoming SPs. By making use of existing signaling structures, the unified framework provides backward compatibility with the existing TWT signaling mechanisms, making it highly practical for real-world deployment within existing wireless networks.

The unified framework may be applied to conventional TWT scenarios, restricted TWT (r-TWT) scenarios, and/or cooperative r-TWT scenarios (cooperative r-TWT is a feature that is expected to be defined in future wireless networking standards). Regardless of the type of TWT being employed, the unified framework may support multiple SP types (e.g., including the hybrid SP type) and SP type signaling to control STA behavior during SPs in a manner that optimizes power efficiency, interoperability, and/or performance (e.g., throughput and/or latency) even in dense or coordinated multi-STA environments. The unified framework may provide a practical, scalable, and forward-compatible enhancement to wireless network power management that can support the evolving demands of next-generation wireless networks.

For purposes of illustration, various embodiments are described herein in the context of wireless networks that are based on IEEE 802.11 standards and using terminology and concepts thereof. Those skilled in the art will appreciate that the embodiments disclosed herein can be modified/adapted for use in other types of wireless networks.

In the following detailed description, only certain embodiments of the present invention have been shown and described, simply by way of illustration. As those skilled in the art would realize, the described embodiments may be modified in different ways, all without departing from the spirit or scope of the present invention. Accordingly, the drawings and description are to be regarded as illustrative in nature and not restrictive. Like reference numerals designate like elements throughout the specification.

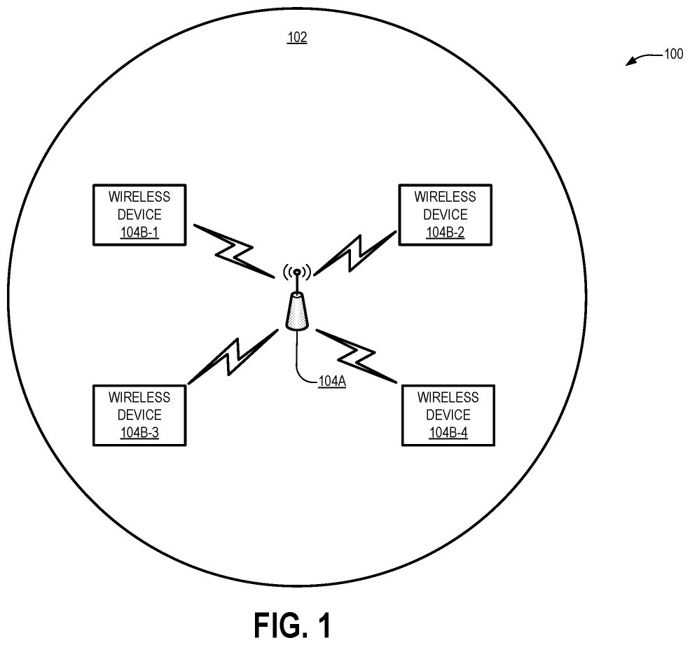

FIG. 1 shows a wireless local area network (WLAN) 100 with a basic service set (BSS) 102 that includes a plurality of wireless devices 104 (sometimes referred to as WLAN devices 104). Each of the wireless devices 104 may include a medium access control (MAC) layer and a physical (PHY) layer according to an IEEE (Institute of Electrical and Electronics Engineers) standard 802.11, including one or more of the amendments (e.g., 802.11a/b/g/n/p/ac/ax/bd/be). In one embodiment, the MAC layer of a wireless device 104 may initiate transmission of a frame to another wireless device 104 by passing a PHY-TXSTART. request (TXVECTOR) to the PHY layer. The TXVECTOR provides parameters for generating and/or transmitting a corresponding frame. Similarly, a PHY layer of a receiving wireless device may generate an RXVECTOR, which includes parameters of a received frame and is passed to a MAC layer for processing.

The plurality of wireless devices 104 may include a wireless device 104A that is an access point (sometimes referred to as an AP station or AP STA) and the other wireless devices 104B₁-104B₄ that are non-AP stations (sometimes referred to as non-AP STAs). Alternatively, all the plurality of wireless devices 104 may be non-AP STAs in an ad-hoc networking environment. In general, the AP STA (e.g., wireless device 104A) and the non-AP STAs (e.g., wireless devices 104B₁-104B₄) may be collectively referred to as STAs. However, for ease of description, only the non-AP STAs may be referred to as STAs unless the context indicates otherwise. Although shown with four non-AP STAs (e.g., the wireless devices 104B₁-104B₄), the WLAN 100 may include any number of non-AP STAs (e.g., one or more wireless devices 104B).

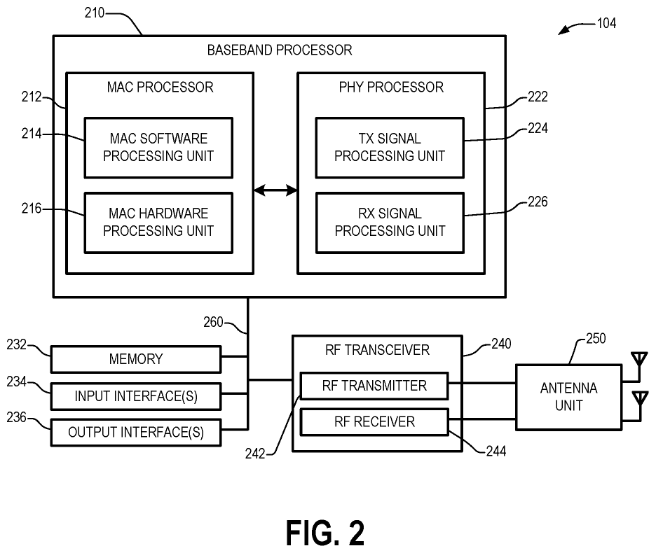

FIG. 2 illustrates a schematic block diagram of a wireless device 104, according to an embodiment. The wireless device 104 may be the wireless device 104A (i.e., the AP of the WLAN 100) or any of the wireless devices 104B₁-104B₄ in FIG. 1. The wireless device 104 includes a baseband processor 210, a radio frequency (RF) transceiver 240, an antenna unit 250, a storage device (e.g., memory device) 232, one or more input interfaces 234, and one or more output interfaces 236. The baseband processor 210, the storage device 232, the input interfaces 234, the output interfaces 236, and the RF transceiver 240 may communicate with each other via a bus 260.

The baseband processor 210 performs baseband signal processing and includes a MAC processor 212 and a PHY processor 222. The baseband processor 210 may utilize the memory 232, which may include a non-transitory computer/machine readable medium having software (e.g., computer/machine programing instructions) and data stored therein.

In an embodiment, the MAC processor 212 includes a MAC software processing unit 214 and a MAC hardware processing unit 216. The MAC software processing unit 214 may implement a first plurality of functions of the MAC layer by executing MAC software, which may be included in the software stored in the storage device 232. The MAC hardware processing unit 216 may implement a second plurality of functions of the MAC layer in special-purpose hardware. However, the MAC processor 212 is not limited thereto. For example, the MAC processor 212 may be configured to perform the first and second plurality of functions entirely in software or entirely in hardware according to an implementation.

The PHY processor 222 includes a transmitting (TX) signal processing unit (SPU) 224 and a receiving (RX) SPU 226. The PHY processor 222 implements a plurality of functions of the PHY layer. These functions may be performed in software, hardware, or a combination thereof according to an implementation.

Functions performed by the transmitting SPU 224 may include one or more of Forward Error Correction (FEC) encoding, stream parsing into one or more spatial streams, diversity encoding of the spatial streams into a plurality of space-time streams, spatial mapping of the space-time streams to transmit chains, inverse Fourier Transform (iFT) computation, Cyclic Prefix (CP) insertion to create a Guard Interval (GI), and the like. Functions performed by the receiving SPU 226 may include inverses of the functions performed by the transmitting SPU 224, such as GI removal, Fourier Transform computation, and the like.

The RF transceiver 240 includes an RF transmitter 242 and an RF receiver 244. The RF transceiver 240 is configured to transmit first information received from the baseband processor 210 to the WLAN 100 (e.g., to another WLAN device 104 of the WLAN 100) and provide second information received from the WLAN 100 (e.g., from another WLAN device 104 of the WLAN 100) to the baseband processor 210.

The antenna unit 250 includes one or more antennas. When Multiple-Input Multiple-Output (MIMO) or Multi-User MIMO (MU-MIMO) is used, the antenna unit 250 may include a plurality of antennas. In an embodiment, the antennas in the antenna unit 250 may operate as a beam-formed antenna array. In an embodiment, the antennas in the antenna unit 250 may be directional antennas, which may be fixed or steerable.

The input interfaces 234 receive information from a user, and the output interfaces 236 output information to the user. The input interfaces 234 may include one or more of a keyboard, keypad, mouse, touchscreen, microphone, and the like. The output interfaces 236 may include one or more of a display device, touch screen, speaker, and the like.

As described herein, many functions of the WLAN device 104 may be implemented in either hardware or software. Which functions are implemented in software and which functions are implemented in hardware will vary according to constraints imposed on a design. The constraints may include one or more of design cost, manufacturing cost, time to market, power consumption, available semiconductor technology, etc.

As described herein, a wide variety of electronic devices, circuits, firmware, software, and combinations thereof may be used to implement the functions of the components of the WLAN device 104. Furthermore, the WLAN device 104 may include other components, such as application processors, storage interfaces, clock generator circuits, power supply circuits, and the like, which have been omitted in the interest of brevity.

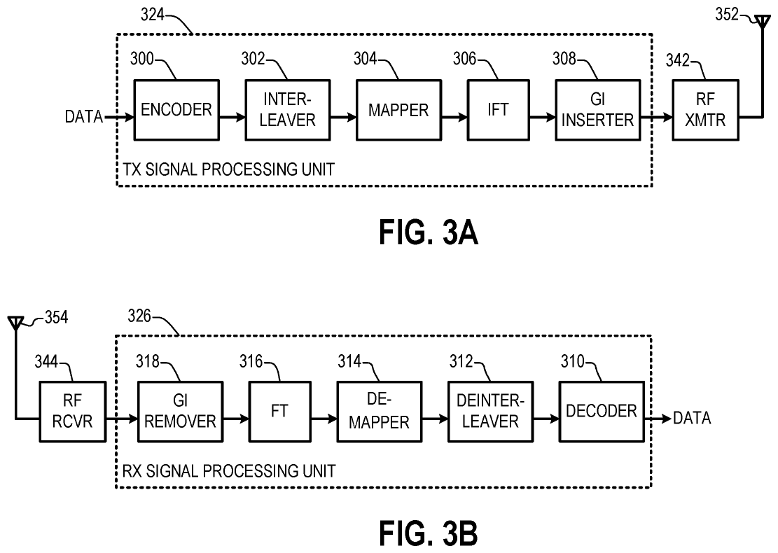

FIG. 3A illustrates components of a WLAN device 104 configured to transmit data according to an embodiment, including a transmitting (Tx) SPU (TxSP) 324, an RF transmitter 342, and an antenna 352. In an embodiment, the TxSP 324, the RF transmitter 342, and the antenna 352 correspond to the transmitting SPU 224, the RF transmitter 242, and an antenna of the antenna unit 250 of FIG. 2, respectively.

The TxSP 324 includes an encoder 300, an interleaver 302, a mapper 304, an inverse Fourier transformer (IFT) 306, and a guard interval (GI) inserter 308.

The encoder 300 receives and encodes input data. In an embodiment, the encoder 300 includes a forward error correction (FEC) encoder. The FEC encoder may include a binary convolution code (BCC) encoder followed by a puncturing device. The FEC encoder may include a low-density parity-check (LDPC) encoder.

The TxSP 324 may further include a scrambler for scrambling the input data before the encoding is performed by the encoder 300 to reduce the probability of long sequences of 0 s or 1 s. When the encoder 300 performs the BCC encoding, the TxSP 324 may further include an encoder parser for demultiplexing the scrambled bits among a plurality of BCC encoders. If LDPC encoding is used in the encoder, the TxSP 324 may not use the encoder parser.

The interleaver 302 interleaves the bits of each stream output from the encoder 300 to change an order of bits therein. The interleaver 302 may apply the interleaving only when the encoder 300 performs BCC encoding and otherwise may output the stream output from the encoder 300 without changing the order of the bits therein.

The mapper 304 maps the sequence of bits output from the interleaver 302 to constellation points. If the encoder 300 performed LDPC encoding, the mapper 304 may also perform LDPC tone mapping in addition to constellation mapping.

When the TxSP 324 performs a MIMO or MU-MIMO transmission, the TxSP 324 may include a plurality of interleavers 302 and a plurality of mappers 304 according to a number of spatial streams (NSS) of the transmission. The TxSP 324 may further include a stream parser for dividing the output of the encoder 300 into blocks and may respectively send the blocks to different interleavers 302 or mappers 304. The TxSP 324 may further include a space-time block code (STBC) encoder for spreading the constellation points from the spatial streams into a number of space-time streams (NSTS) and a spatial mapper for mapping the space-time streams to transmit chains. The spatial mapper may use direct mapping, spatial expansion, or beamforming.

The IFT 306 converts a block of the constellation points output from the mapper 304 (or, when MIMO or MU-MIMO is performed, the spatial mapper) to a time domain block (i.e., a symbol) by using an inverse discrete Fourier transform (IDFT) or an inverse fast Fourier transform (IFFT). If the STBC encoder and the spatial mapper are used, the IFT 306 may be provided for each transmit chain.

When the TxSP 324 performs a MIMO or MU-MIMO transmission, the TxSP 324 may insert cyclic shift diversities (CSDs) to prevent unintentional beamforming. The TxSP 324 may perform the insertion of the CSD before or after the IFT 306. The CSD may be specified per transmit chain or may be specified per space-time stream. Alternatively, the CSD may be applied as a part of the spatial mapper.

When the TxSP 324 performs a MIMO or MU-MIMO transmission, some blocks before the spatial mapper may be provided for each user.

The GI inserter 308 prepends a GI to each symbol produced by the IFT 306. Each GI may include a Cyclic Prefix (CP) corresponding to a repeated portion of the end of the symbol that the GI precedes. The TxSP 324 may optionally perform windowing to smooth edges of each symbol after inserting the GI.

The RF transmitter 342 converts the symbols into an RF signal and transmits the RF signal via the antenna 352. When the TxSP 324 performs a MIMO or MU-MIMO transmission, the GI inserter 308 and the RF transmitter 342 may be provided for each transmit chain.

FIG. 3B illustrates components of a WLAN device 104 configured to receive data according to an embodiment, including a Receiver (Rx) SPU (RxSP) 326, an RF receiver 344, and an antenna 354. In an embodiment, the RxSP 326, RF receiver 344, and antenna 354 may correspond to the receiving SPU 226, the RF receiver 244, and an antenna of the antenna unit 250 of FIG. 2, respectively.

The RxSP 326 includes a GI remover 318, a Fourier transformer (FT) 316, a demapper 314, a deinterleaver 312, and a decoder 310.

The RF receiver 344 receives an RF signal via the antenna 354 and converts the RF signal into symbols. The GI remover 318 removes the GI from each of the symbols. When the received transmission is a MIMO or MU-MIMO transmission, the RF receiver 344 and the GI remover 318 may be provided for each receive chain.

The FT 316 converts each symbol (that is, each time domain block) into a frequency domain block of constellation points by using a discrete Fourier transform (DFT) or a fast Fourier transform (FFT). The FT 316 may be provided for each receive chain.

When the received transmission is the MIMO or MU-MIMO transmission, the RxSP 326 may include a spatial demapper for converting the respective outputs of the FTs 316 of the receiver chains to constellation points of a plurality of space-time streams, and an STBC decoder for despreading the constellation points from the space-time streams into one or more spatial streams.

The demapper 314 demaps the constellation points output from the FT 316 or the STBC decoder to bit streams. If the received transmission was encoded using LDPC encoding, the demapper 314 may further perform LDPC tone demapping before performing the constellation demapping.

The deinterleaver 312 deinterleaves the bits of each stream output from the demapper 314. The deinterleaver 312 may perform the deinterleaving only when the received transmission was encoded using BCC encoding, and otherwise may output the stream output by the demapper 314 without performing deinterleaving.

When the received transmission is the MIMO or MU-MIMO transmission, the RxSP 326 may use a plurality of demappers 314 and a plurality of deinterleavers 312 corresponding to the number of spatial streams of the transmission. In this case, the RxSP 326 may further include a stream deparser for combining the streams output from the deinterleavers 312.

The decoder 310 decodes the streams output from the deinterleaver 312 or the stream deparser. In an embodiment, the decoder 310 includes an FEC decoder. The FEC decoder may include a BCC decoder or an LDPC decoder.

The RxSP 326 may further include a descrambler for descrambling the decoded data. When the decoder 310 performs BCC decoding, the RxSP 326 may further include an encoder deparser for multiplexing the data decoded by a plurality of BCC decoders. When the decoder 310 performs the LDPC decoding, the RxSP 326 may not use the encoder deparser.

Before making a transmission, wireless devices such as wireless device 104 will assess the availability of the wireless medium using Clear Channel Assessment (CCA). If the medium is occupied, CCA may determine that it is busy, while if the medium is available, CCA determines that it is idle.

The PHY entity for IEEE 802.11 is based on Orthogonal Frequency Division Multiplexing (OFDM) or Orthogonal Frequency Division Multiple Access (OFDMA). In either OFDM or OFDMA Physical (PHY) layers, a STA (e.g., a wireless device 104) is capable of transmitting and receiving Physical Layer (PHY) Protocol Data Units (PPDUs) (also referred to as PLCP (Physical Layer Convergence Procedure) Protocol Data Units) that are compliant with the mandatory PHY specifications. A PHY specification defines a set of Modulation and Coding Schemes (MCS) and a maximum number of spatial streams. Some PHY entities define downlink (DL) and uplink (UL) Multi-User (MU) transmissions having a maximum number of space-time streams (STS) per user and employing up to a predetermined total number of STSs. A PHY entity may provide support for 10 Megahertz (MHz), 20 MHz, 40 MHz, 80 MHz, 160 MHz, 240 MHz, and 320 MHz contiguous channel widths and support for an 80+80, 80+160 MHz, and 160+160 MHz non-contiguous channel width. Each channel includes a plurality of subcarriers, which may also be referred to as tones. A PHY entity may define signaling fields denoted as Legacy Signal (L-SIG), Signal A (SIG-A), and Signal B (SIG-B), and the like within a PPDU by which some necessary information about PHY Service Data Unit (PSDU) attributes are communicated. The descriptions below, for sake of completeness and brevity, refer to OFDM-based 802.11 technology. Unless otherwise indicated, a station refers to a non-AP STA.

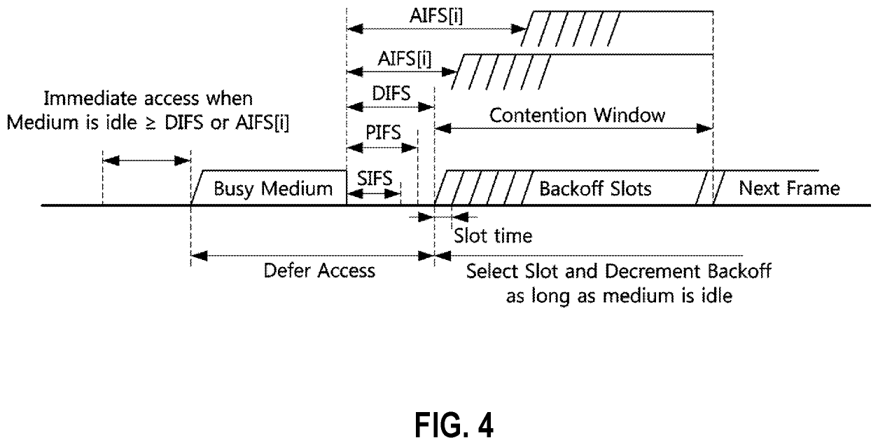

FIG. 4 illustrates Inter-Frame Space (IFS) relationships. In particular, FIG. 4 illustrates a Short IFS (SIFS), a Point Coordination Function (PCF) IFS (PIFS), a Distributed Coordination Function (DCF) IFS (DIFS), and an Arbitration IFSs corresponding to an Access Category (AC) ‘i’ (AIFS[i]). FIG. 4 also illustrates a slot time and a data frame is used for transmission of data forwarded to a higher layer. As shown, a WLAN device 104 transmits the data frame after performing backoff if a DIFS has elapsed during which the medium has been idle.

A management frame may be used for exchanging management information, which is not forwarded to the higher layer. Subtype frames of the management frame include a beacon frame, an association request/response frame, a probe request/response frame, and an authentication request/response frame.

A control frame may be used for controlling access to the medium. Subtype frames of the control frame include a request to send (RTS) frame, a clear to send (CTS) frame, and an acknowledgement (ACK) frame.

When the control frame is not a response frame of another frame, the WLAN device 104 transmits the control frame after performing backoff if a DIFS has elapsed during which the medium has been idle. When the control frame is the response frame of another frame, the WLAN device 104 transmits the control frame after a SIFS has elapsed without performing backoff or checking whether the medium is idle.

A WLAN device 104 that supports Quality of Service (QoS) functionality (that is, a QoS STA) may transmit the frame after performing backoff if an AIFS for an associated access category (AC) (i.e., AIFS[AC]) has elapsed. When transmitted by the QoS STA, any of the data frame, the management frame, and the control frame, which is not the response frame, may use the AIFS[AC] of the AC of the transmitted frame.

A WLAN device 104 may perform a backoff procedure when the WLAN device 104 that is ready to transfer a frame finds the medium busy. The backoff procedure includes determining a random backoff time composed of N backoff slots, where each backoff slot has a duration equal to a slot time and N being an integer number greater than or equal to zero. The backoff time may be determined according to a length of a Contention Window (CW). In an embodiment, the backoff time may be determined according to an AC of the frame. All backoff slots occur following a DIFS or Extended IFS (EIFS) period during which the medium is determined to be idle for the duration of the period.

When the WLAN device 104 detects no medium activity for the duration of a particular backoff slot, the backoff procedure shall decrement the backoff time by the slot time. When the WLAN device 104 determines that the medium is busy during a backoff slot, the backoff procedure is suspended until the medium is again determined to be idle for the duration of a DIFS or EIFS period. The WLAN device 104 may perform transmission or retransmission of the frame when the backoff timer reaches zero.

The backoff procedure operates so that when multiple WLAN devices 104 are deferring and execute the backoff procedure, each WLAN device 104 may select a backoff time using a random function and the WLAN device 104 that selects the smallest backoff time may win the contention, reducing the probability of a collision.

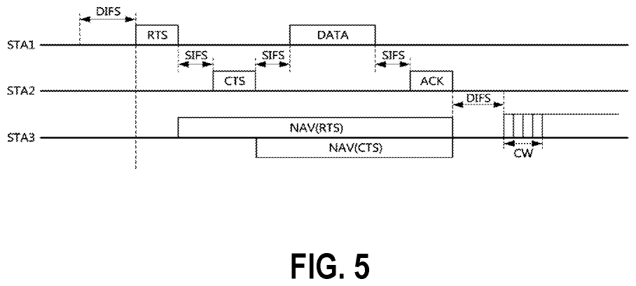

FIG. 5 illustrates a Carrier Sense Multiple Access/Collision Avoidance (CSMA/CA) based frame transmission procedure for avoiding collision between frames in a channel according to an embodiment. FIG. 5 shows a first station STA1 transmitting data, a second station STA2 receiving the data, and a third station STA3 that may be located in an area where a frame transmitted from the STA1 can be received, a frame transmitted from the second station STA2 can be received, or both can be received. The stations STA1, STA2, and STA3 may be WLAN devices 104 of FIG. 1.

The station STA1 may determine whether the channel is busy by carrier sensing. The station STA1 may determine channel occupation/status based on an energy level in the channel or an autocorrelation of signals in the channel, or may determine the channel occupation by using a network allocation vector (NAV) timer.

After determining that the channel is not used by other devices (that is, that the channel is IDLE) during a DIFS (and performing backoff if required), the station STA1 may transmit a Request-To-Send (RTS) frame to the station STA2. Upon receiving the RTS frame, after a SIFS the station STA2 may transmit a Clear-To-Send (CTS) frame as a response to the RTS frame. If Dual-CTS is enabled and the station STA2 is an AP, the AP may send two CTS frames in response to the RTS frame (e.g., a first CTS frame in a non-High Throughput format and a second CTS frame in the HT format).

When the station STA3 receives the RTS frame, it may set a NAV timer of the station STA3 for a transmission duration of subsequently transmitted frames (for example, a duration of SIFS+CTS frame duration+SIFS+data frame duration+SIFS+ACK frame duration) using duration information included in the RTS frame. When the station STA3 receives the CTS frame, it may set the NAV timer of the station STA3 for a transmission duration of subsequently transmitted frames using duration information included in the CTS frame. Upon receiving a new frame before the NAV timer expires, the station STA3 may update the NAV timer of the station STA3 by using duration information included in the new frame. The station STA3 does not attempt to access the channel until the NAV timer expires.

When the station STA1 receives the CTS frame from the station STA2, it may transmit a data frame to the station STA2 after a SIFS period elapses from a time when the CTS frame has been completely received. Upon successfully receiving the data frame, the station STA2 may transmit an ACK frame as a response to the data frame after a SIFS period elapses.

When the NAV timer expires, the third station STA3 may determine whether the channel is busy using the carrier sensing. Upon determining that the channel is not used by other devices during a DIFS period after the NAV timer has expired, the station STA3 may attempt to access the channel after a contention window elapses according to a backoff process.

When Dual-CTS is enabled, a station that has obtained a transmission opportunity (TXOP) and that has no data to transmit may transmit a CF-End frame to cut short the TXOP. An AP receiving a CF-End frame having a Basic Service Set Identifier (BSSID) of the AP as a destination address may respond by transmitting two more CF-End frames: a first CF-End frame using Space Time Block Coding (STBC) and a second CF-End frame using non-STBC. A station receiving a CF-End frame resets its NAV timer to 0 at the end of the PPDU containing the CF-End frame. FIG. 5 shows the station STA2 transmitting an ACK frame to acknowledge the successful reception of a frame by the recipient.

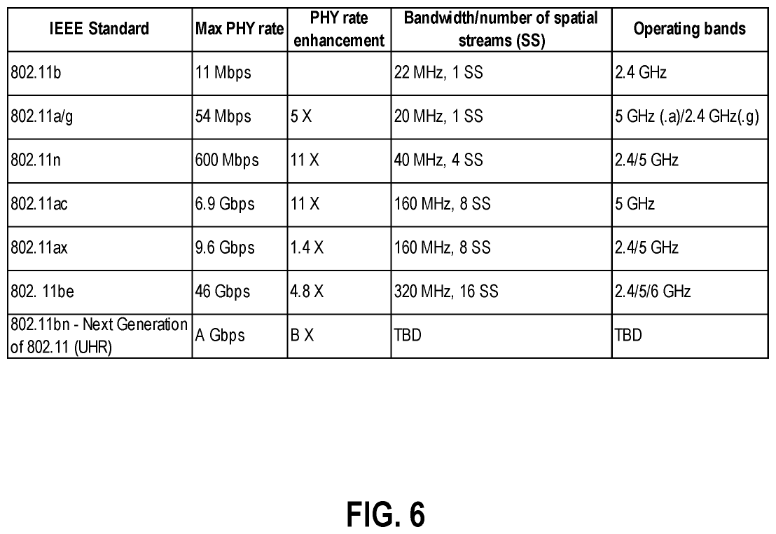

The IEEE 802.11bn (Ultra High Reliability, UHR) working group has been established to address the growing demand for higher peak throughput and reliability in Wi-Fi. As shown in FIG. 6, the peak PHY rate has significantly increased from IEEE 802.11b to IEEE 802.11be (Wi-Fi 7), with the latter focusing on further improving peak throughput. The UHR study group aims to enhance the tail of the latency distribution and jitter to support applications that require low latency, such as video-over-WLAN, gaming, AR, and VR. It is noted that various characteristics of UHR (e.g., max PHY rate, PHY rate enhancement, bandwidth/number of spatial streams, and operating bands) are still to be determined.

The focus of IEEE 802.11be is primarily on WLAN indoor and outdoor operation with stationary and pedestrian speeds in the 2.4, 5, and 6 GHz frequency bands. In addition to peak PHY rate, different candidate features are under discussion. These candidate features include (1) a 320 MHz bandwidth and a more efficient utilization of a non-contiguous spectrum, (2) multi-band/multi-channel aggregation and operation, (3) 16 spatial streams and Multiple Input Multiple Output (MIMO) protocol enhancements, (4) multi-Access Point (AP) Coordination (e.g., coordinated and joint transmission), (5) an enhanced link adaptation and retransmission protocol (e.g., Hybrid Automatic Repeat Request (HARQ)), and (6) adaptation to regulatory rules specific to a 6 GHz spectrum.

The focus of IEEE 802.11bn (UHR) is still under discussion, with candidate features including MLO enhancements (e.g., in terms of increased throughput/reliability and decreased latency), latency and reliability improvements (e.g., multi-AP coordination to support low latency traffic), bandwidth expansion (e.g., to 240, 480, 640 MHz), aggregated PPDU (A-PPDU), enhanced multi-link single-radio (eMLSR) extensions to AP, roaming improvements, and power-saving schemes for prolonging battery life.

Some features, such as increasing the bandwidth and the number of spatial streams, are solutions that have been proven to be effective in previous projects focused on increasing link throughput and on which feasibility demonstration is achievable.

With respect to operational bands (e.g., 2.4/5/6 GHz) for IEEE 802.11be, more than 1 GHz of additional unlicensed spectrum is likely to be available because the 6 GHz band (5.925-7.125 GHz) is being considered for unlicensed use. This would allow APs and STAs to become tri-band devices. Larger than 160 MHz data transmissions (e.g., 320 MHz or 640 MHz) could be considered to increase the maximum PHY rate. For example, 320 MHz or 160+160 MHz data could be transmitted in the 6 GHz band. For example, 160+160 MHz data could be transmitted across the 5 and 6 GHz bands.

In the process of wireless communication, a transmitting station (STA) creates a Physical Layer Protocol Data Unit (PPDU) frame and sends it to a receiving STA. The receiving STA then receives, detects, and processes the PPDU.

The Extremely High Throughput (EHT) PPDU frame encompasses several components. It includes a legacy part, which comprises fields such as the Legacy Short Training Field (L-STF), Legacy Long Training Field (L-LTF), Legacy Signal Field (L-SIG), and Repeated Legacy Signal Field (RL-SIG). These fields are used to maintain compatibility with older Wi-Fi standards.

In addition to the legacy part, the EHT PPDU frame also contains the Universal Signal Field (U-SIG), EHT Signal Field (EHT-SIG), EHT Short Training Field (EHT-STF), and EHT Long Training Field (EHT-LTF). These fields are specific to the EHT standard and are used for various purposes, such as signaling, synchronization, and channel estimation.

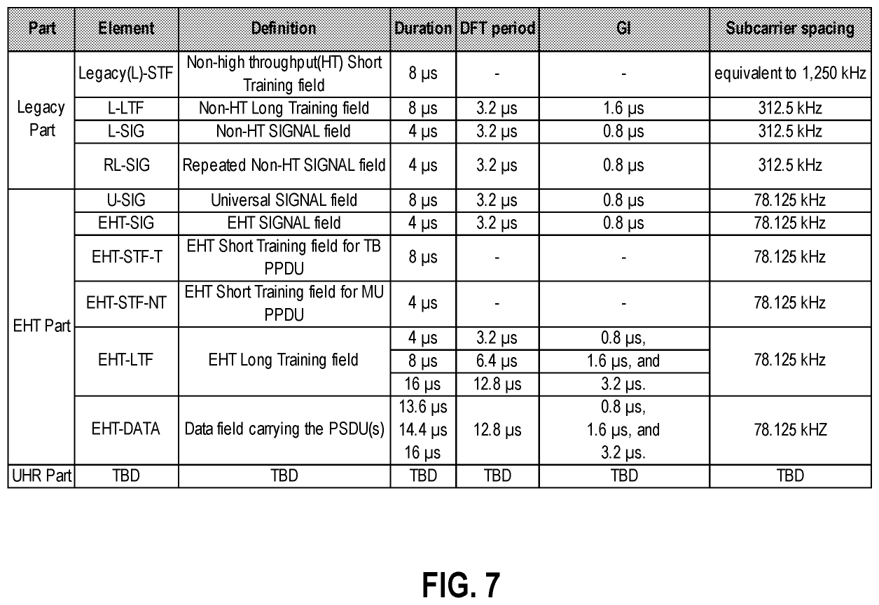

FIG. 7 provides a more detailed description of each field in the EHT PPDU frame, including their purposes and characteristics.

Regarding the Ultra High Reliability (UHR) PPDU, its frame structure is currently undefined and will be determined through further discussions within the relevant working group or study group. This indicates that the specifics of the UHR PPDU are still under development and will be finalized based on the outcomes of future deliberations.

The distributed nature of channel access networks, such as IEEE 802.11 WLANs, makes the carrier sense mechanism useful for ensuring collision-free operation. Each station (STA) uses its physical carrier sense to detect transmissions from other STAs. However, in certain situations, it may not be possible for a STA to detect every transmission. For instance, when one STA is located far away from another STA, it might perceive the medium as idle and start transmitting a frame, leading to collisions. To mitigate this hidden node problem, the network allocation vector (NAV) has been introduced.

As the IEEE 802.11 standard continues to evolve, it now includes scenarios where multiple users can simultaneously transmit or receive data within a basic service set (BSS), such as uplink (UL) and downlink (DL) multi-user (MU) transmissions in a cascaded manner. In these cases, the existing carrier sense and NAV mechanisms may not be sufficient, and modifications or newly defined mechanisms may be required to facilitate efficient and collision-free operation.

For the purpose of this disclosure, MU transmission refers to situations where multiple frames are transmitted to or from multiple STAs simultaneously using different resources. Examples of these resources include different frequency resources in Orthogonal Frequency Division Multiple Access (OFDMA) transmission and different spatial streams in Multi-User Multiple Input Multiple Output (MU-MIMO) transmission. Consequently, downlink OFDMA (DL-OFDMA), downlink MU-MIMO (DL-MU-MIMO), uplink OFDMA (UL-OFDMA), uplink MU-MIMO (UL-MU-MIMO), and OFDMA with MU-MIMO are all considered examples of MU transmission.

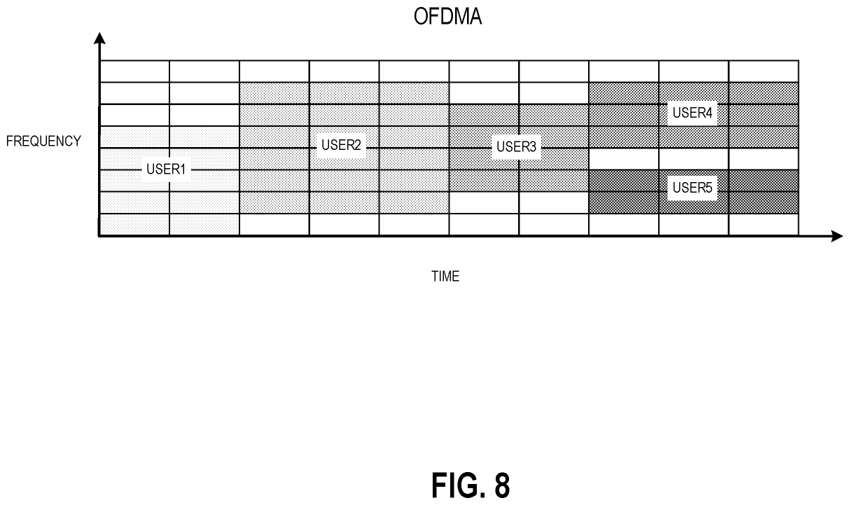

FIG. 8 illustrates an example of multi-user (MU) transmission in Orthogonal Frequency-Division Multiple Access (OFDMA), in accordance with some embodiments of the present disclosure.

In the IEEE 802.11ax and 802.11be specifications, the trigger frame plays a useful role in facilitating uplink multi-user (MU) transmissions. The purpose of the trigger frame is to allocate resources and solicit one or more Trigger-based (TB) Physical Layer Protocol Data Unit (PPDU) transmissions from the associated stations (STAs).

The trigger frame contains information required by the responding STAs to send their Uplink TB PPDUs. This information includes the Trigger type, which specifies the type of TB PPDU expected, and the Uplink Length (UL Length), which indicates the duration of the uplink transmission.

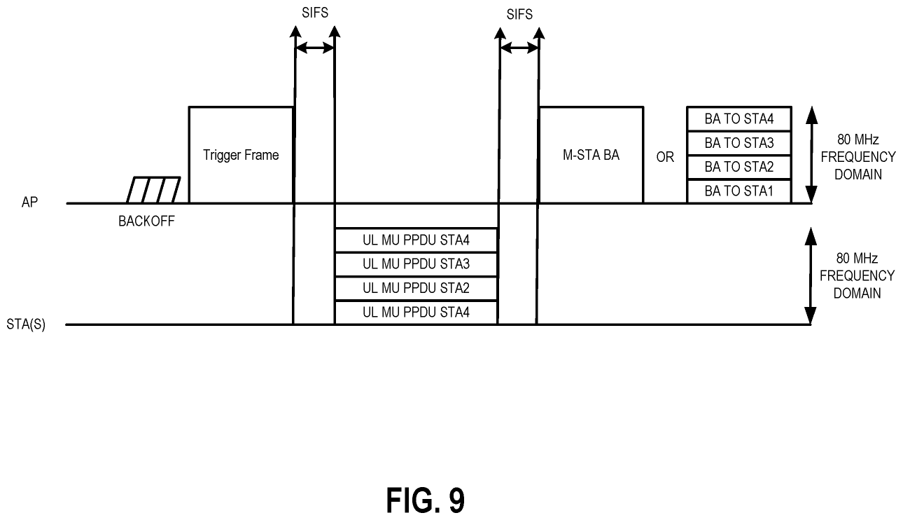

FIG. 9 illustrates an example scenario where an access point (AP) operating in an 80 MHz bandwidth environment sends a Trigger frame to multiple associated STAs. Upon receiving the Trigger frame, the STAs respond by sending their respective Uplink Orthogonal Frequency Division Multiple Access (UL OFDMA) TB PPDUs, utilizing the allocated resources within the specified 80 MHz bandwidth.

After successfully receiving the UL OFDMA TB PPDUs, the AP acknowledges the STAs by sending an acknowledgement frame. This acknowledgement can be in the form of an 80 MHz width multi-STA Block Acknowledgement (Block Ack) or a Block Acknowledgement with a Direct Feedback (DF) OFDMA method. The multi-STA Block Ack allows the AP to acknowledge multiple STAs simultaneously, while the Block Ack with DF OFDMA enables the AP to provide feedback to the STAs using the same OFDMA technique employed in the uplink transmission.

The trigger frame is a useful component in enabling efficient uplink MU transmissions in IEEE 802.11ax and 802.11be networks, by allocating resources and coordinating the uplink transmissions from multiple STAs within the same bandwidth.

Wireless network systems can rely on retransmission of media access control (MAC) protocol data units (MPDUs) when the transmitter (TX) does not receive an acknowledgement from the receiver (RX) or MPDUs are not successfully decoded by the receiver. Using an automatic repeat request (ARQ) approach, the receiver discards the last failed MPDU before receiving the newly retransmitted MPDU. With requirements of enhanced reliability and reduced latency, the wireless network system can evolve toward a hybrid ARQ (HARQ) approach.

There are two methods of HARQ processing. In a first type of HARQ scheme, also referred to as chase combining (CC) HARQ (CC-HARQ) scheme, signals to be retransmitted are the same as the signals that previously failed because all subpackets to be retransmitted use the same puncturing pattern. The puncturing is needed to remove some of the parity bits after encoding using an error-correction code. The reason why the same puncturing pattern is used with CC-HARQ is to generate a coded data sequence with forward error correction (FEC) and to make the receiver use a maximum-ratio combining (MRC) to combine the received, retransmitted bits with the same bits from the previous transmission. For example, information sequences are transmitted in packets with a fixed length. At a receiver, error correction and detection are carried out over the whole packet. However, the ARQ scheme may be inefficient in the presence of burst errors. To solve this more efficiently, subpackets are used. In subpacket transmissions, only those subpackets that include errors need to be retransmitted.

Since the receiver uses both the current and the previously received subpackets for decoding data, the error probability in decoding decreases as the number of used subpackets increases. The decoding process passes a cyclic redundancy check (CRC) and ends when the entire packet is decoded without error or the maximum number of subpackets is reached. In particular, this scheme operates on a stop-and-wait protocol such that if the receiver can decode the packet, it sends an acknowledgement (ACK) to the transmitter. When the transmitter receives an ACK successfully, it terminates the HARQ transmission of the packet. If the receiver cannot decode the packet, it sends a negative acknowledgement (NAK) to the transmitter and the transmitter performs the retransmission process.

In a second type of HARQ scheme, also referred to as an incremental redundancy (IR) HARQ (IR-HARQ) scheme, different puncturing patterns are used for each subpacket such that the signal changes for each retransmitted subpacket in comparison to the originally transmitted subpacket. IR-HARQ alternatively uses two puncturing patterns for odd numbered and even numbered transmissions, respectively. The redundancy scheme of IR-HARQ improves the log likelihood ratio (LLR) of parity bit(s) in order to combine information sent across different transmissions due to requests and lowers the code rate as the additional subpacket is used. This results in a lower error rate of the subpacket in comparison to CC-HARQ. The puncturing pattern used in IR-HARQ is indicated by a subpacket identity (SPID) indication. The SPID of the first subpacket may always be set to 0 and all the systematic bits and the punctured parity bits are transmitted in the first subpacket. Self-decoding is possible when the receiving signal-to-noise ratio (SNR) environment is good (i.e., a high SNR). In some embodiments, subpackets with corresponding SPIDs to be transmitted are in increasing order of SPID but can be exchanged/switched except for the first SPID.

AP coordination has been considered as a potential technology to improve WLAN system throughput in the IEEE 802.11be standard and is still being discussed in the IEEE 802.11bn (UHR) standard. To support various AP coordination schemes, such as coordinated beamforming, OFDMA, TDMA, spatial reuse, and joint transmission, a predefined mechanism for APs is necessary.

In the context of coordinated TDMA (C-TDMA), the AP that obtains a transmit opportunity (TXOP) is referred to as the sharing AP. This AP initiates the AP coordination schemes to determine the AP candidate set by sending a frame, such as a Beacon frame or probe response frame, which includes information about the AP coordination scheme capabilities. The AP that participates in the AP coordination schemes after receiving the frame from the sharing AP is called the shared AP. The sharing AP is also known as the master AP or coordinating AP, while the shared AP is referred to as the slave AP or coordinated AP.

The operation of various AP coordination schemes has been discussed in the IEEE 802.11be and UHR standards:

Coordinated Beamforming (C-BF): Multiple APs transmit on the same frequency resource by coordinating and forming spatial nulls, allowing for simultaneous transmission from multiple APs.

Coordinated OFDMA (C-OFDMA): APs transmit on orthogonal frequency resources by coordinating and splitting the spectrum, enabling more efficient spectrum utilization.

Joint Transmission (JTX): Multiple APs transmit jointly to a given user simultaneously by sharing data between the APs.

Coordinated Spatial Reuse (C-SR): Multiple APs or STAs adjust their transmit power to reduce interference between APs.

By implementing these AP coordination schemes, WLAN systems can improve their overall throughput and efficiency by leveraging the cooperation between multiple APs.

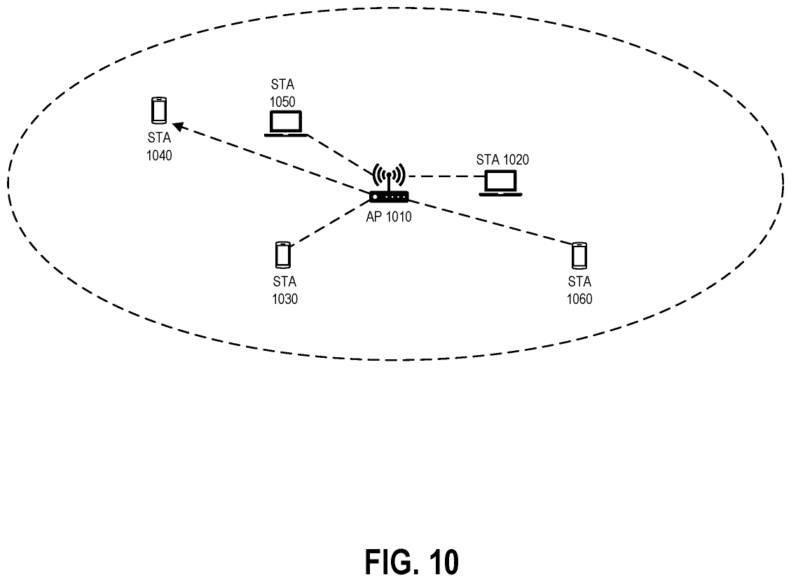

FIG. 10 is a diagram showing a wireless network environment that can implement a unified framework that integrates DPS features and TWT features, according to some embodiments.

As shown in the diagram, the wireless network environment may include an AP 1010 and five non-AP STAs that are associated with the AP (STA 1020, STA 1030, STA 1040, STA 1050, and STA 1060). The STAs may be implemented by any type of wireless device such as a mobile device, IoT device, or the like. As will be described herein, the wireless network environment may implement a unified framework that incorporates DPS features and TWT features to improve energy efficiency and network performance.

Each STA may support DPS or a similar dynamic power saving scheme. For sake of explanation, it is assumed that the STAs support DPS. A STA that supports DPS may dynamically transition between operating in a low capability (LC) mode and operating in a high capability (HC) mode. Also, each STA may support TWT or a similar scheduled power saving scheme. For sake of explanation, it is assumed that the STAs support TWT. A STA that supports TWT may wake up according to a pre-negotiated schedule and transmit data, thereby reducing its power consumption while still being able to utilize the channel.

For sake of explanation only, various embodiments may be described herein in the context of the wireless network environment shown in FIG. 10. It should be appreciated, however, that the techniques/framework described herein may be applicable to other wireless network environments having different configurations.

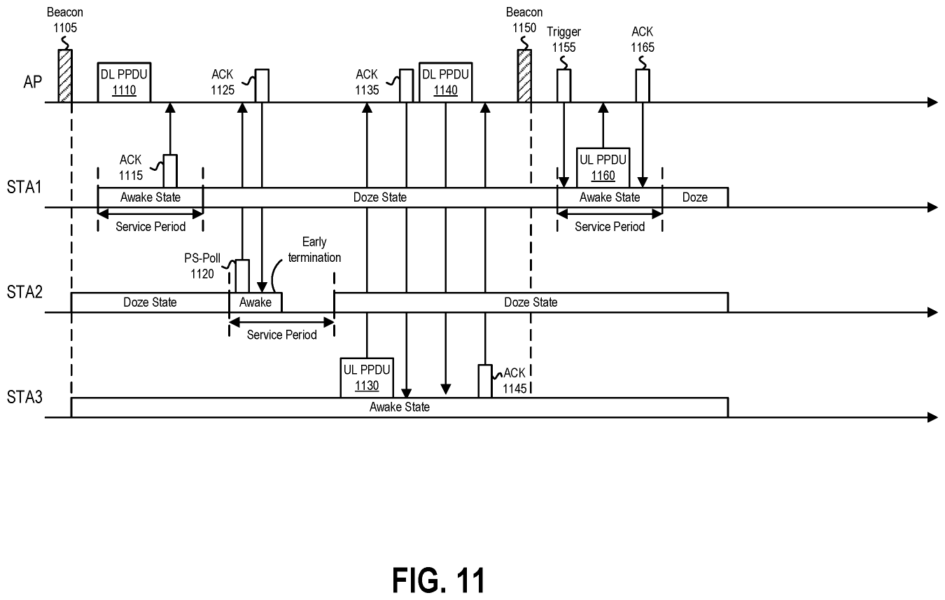

FIG. 11 is a diagram showing frame exchange sequences for uplink (UL) and downlink (DL) communications with and without using TWT, according to some embodiments.

The diagram shows two different frame exchange scenarios between an AP and associated STAs (STA1, STA2, and STA3) to provide a comparison between TWT-enabled power saving operation and conventional always-active communications.

The first scenario involves STA1 and STA2, which employ a TWT-based power saving strategy to reduce power consumption. These STAs may primarily remain in the doze state to conserve power and only wake up from the doze state during predefined service periods (SPs) scheduled by the AP. During a SP, these STAs can actively transmit and receive data, ensuring efficient communication. Once the data exchange has finished, these STAs may enter the doze state again to reduce power consumption.

In some cases, a SP may be terminated early (an event referred to as SP early termination) if data transmission is complete/finished before the SP is scheduled to end. Such a termination mechanism improves overall energy efficiency by allowing the STA to enter the doze state sooner so as to avoid idle power usage.

For example, as shown in the diagram, the AP may transmit beacon frame 1105 to schedule SPs for STA1 and STA2. In this example, STA1 and STA2 have different SP schedules. At the beginning of STA1's SP, STA1 may enter the awake state. During this SP, the AP may transmit downlink physical layer protocol data unit (DL PPDU) 1110 to STA1 and STA1 may transmit acknowledgement (ACK) frame 1115 to the AP as a response. When STA1's SP ends, STA1 may enter the doze state to conserve power. Similarly, at the beginning of STA2's SP, STA2 may enter the awake state. During this SP, STA2 may transmit a power save poll (PS-Poll) frame 1120 to the AP to indicate that it does not have any data to transmit during the current SP. The AP may then transmit ACK frame 1125 to STA2 as a response, and the SP may be terminated early (“Early termination”). At the beginning of STA1's next SP, STA1 may enter the awake state again. During this SP, the AP may transmit trigger frame 1155 to STA1 to solicit an uplink transmission from STA1. Responsive to receiving trigger frame 1155, STA1 may transmit uplink physical layer protocol data unit (UL PPDU) 1160 to the AP. The AP may then transmit ACK frame 1165 to STA1 as a response. When STA1's SP ends, STA1 may enter the doze state again to conserve power. The AP may periodically transmit beacon frames such as beacon frame 1150 to announce the SP schedules.

The second scenario involves STA3, which does not support TWT and thus continuously stays in the awake state regardless of whether it has data to transmit/receive. Since STA3 does not have any scheduled sleep intervals and has to continuously listen to the wireless medium even when no data is being exchanged, it consumes significantly more power (e.g., compared to STA1 and STA2).

For example, as shown in the diagram, STA3 is always in the awake state and may transmit UL PPDU 1130 to the AP after STA2's SP ends. The AP may transmit ACK frame 1135 to STA3 as a response. Also, the AP may transmit DL PPDU 1140 to STA3 and STA3 may transmit ACK frame 1145 as a response. The absence of an efficient wake/sleep mechanism/schedule results in higher power consumption, making this approach less suitable for energy-sensitive devices such as IoT devices or battery-powered mobile stations.

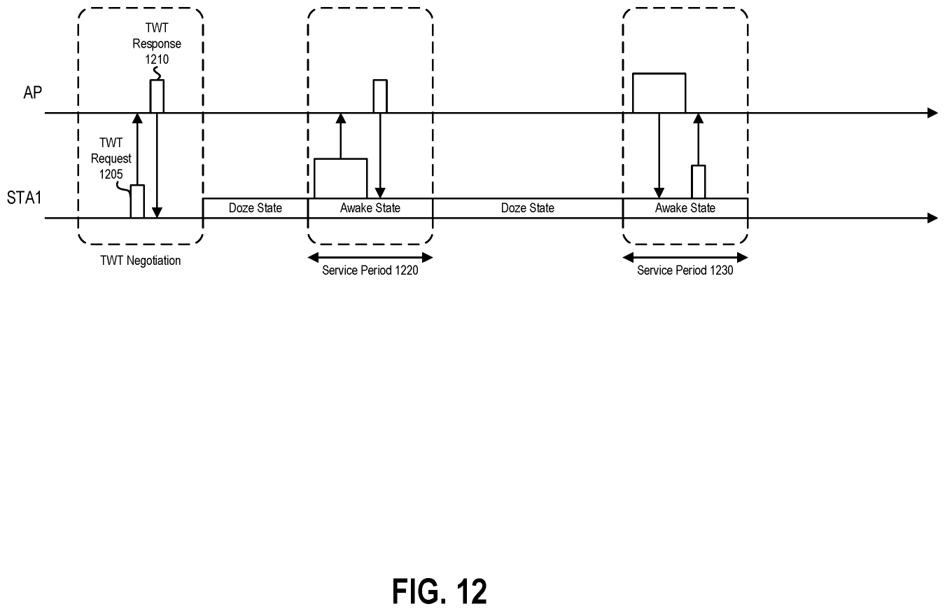

FIG. 12 is a diagram showing a TWT negotiation process, according to some embodiments.

The diagram shows a TWT negotiation process that allows an AP and a STA to establish a wake-up schedule for improved power efficiency and optimized channel utilization. TWT may provide two types of TWTs: 1) broadcast TWT; and 2) individual TWT. With broadcast TWT, the AP defines a shared wake-up schedule for multiple STAs and transmits a beacon frame announcing the schedule to allow the STAs to synchronize their transmissions. In contrast, with individual TWT, a STA and an AP directly negotiate a customized wake-up schedule with each other. The negotiation process shown in the diagram is an example of negotiating an individual TWT.

As shown in the diagram, STA1 may initiate the negotiation process by transmitting TWT request frame 1205 to the AP. The AP may respond by transmitting TWT response frame 1210 to STA1. TWT response frame 1210 may specify the parameters for the scheduled wake-up periods (the schedule for the SPs). Once the negotiation is complete, STA1 may operate according to the agreed-upon schedule, alternating between being in the awake state and the doze state to conserve power. In this example, it is assumed that the negotiation resulted in the scheduling of SP 1220 and SP 1230.

According to existing TWT behavior, the assumption is that a STA is in the awake state and operates at full capacity during the entire duration of a scheduled SP. That is, once the STA wakes up for a scheduled SP, it is expected to function with full transmission and reception capability until the SP is over.

For example, as shown in the diagram, STA1 may leave the doze state and enter the awake state at the beginning of a scheduled SP 1220. STA1 may stay in the awake state for the entire duration of SP 1220 and exchange frames with the AP during this SP 1220. STA1 may enter the doze state when SP 1220 ends. STA1 may then again leave the doze state and enter the awake state at the beginning of the next scheduled SP 1230. STA1 may stay in the awake state for the entire duration of SP 1230 and exchange frames with the AP during this SP 1230.

By implementing a TWT negotiation process, wireless networks can support multiple STAs having individual/customized wake-up schedules, ensuring efficient coordination of transmissions in dense wireless network environments. The use of TWT allows STAs to conserve power while still maintaining reliable communication with the AP.

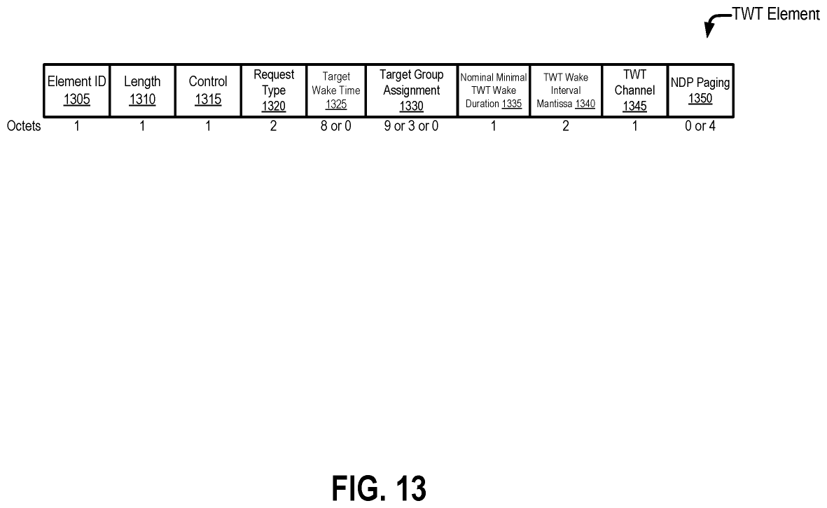

FIG. 13 is a diagram showing TWT element format for specifying a wake interval and minimum wake duration, according to some embodiments.

A TWT element may specify the key parameters for managing the duty cycle of wake-up periods. By configuring these parameters, the wireless network can schedule wake-up times for STAs.

As shown in the diagram, the TWT element may include an element ID field 1305 (1 octet), a length field 1310 (1 octet), a control field 1315 (1 octet), a request type field 1320 (2 octets), a target wake time field 1325 (8 or 0 octets), a target group assignment field 1330 (9 or 3 or 0 octets), a nominal minimal TWT wake duration field 1335 (1 octet), a TWT wake interval mantissa field 1340 (2 octets), a TWT channel field 1345 (1 octet), and a null data packet (NDP) paging field 1350 (0 or 4 octets).

One of the important parameters specified in the TWT element is the TWT wake interval. The TWT wake interval may be specified in the TWT wake interval mantissa field 1340 of the TWT element. The TWT wake interval may define how frequently a STA should wake up to communicate with the AP. Ideally, this value should be greater than zero to ensure periodic wake-up cycles. In practical implementations, the minimum TWT wake interval is often set to 10 milliseconds to achieve a balance between power efficiency and timely communication

Another important parameter that is specified in the TWT element is the minimum TWT wake duration. The minimum TWT wake duration may be specified in the nominal minimal TWT wake duration field 1335 of the TWT element. The minimum TWT wake duration may define the minimum time that a STA must remain in the awake state after the start of a TWT SP. The STA is expected to stay in the awake state for at least the minimum TWT wake duration to enable the STA to communicate with the AP or other STAs before entering the doze state to conserve power. The target wake time field 1325 may specify the timing of the first wake-up instance of the STA under the TWT agreement. By ensuring that STAs remain awake for at least a predefined minimum duration, the wireless network guarantees that essential communications can be processed while still providing power-saving benefits.

Thus, the TWT wake interval controls how frequently STAs wake up, while the minimum TWT wake duration ensures that STAs remain awake long enough to process essential communications.

For sake of brevity, only certain fields of the TWT element that are deemed to be relevant to the understanding of embodiments are described in detail herein. The other fields of the TWT element can be interpreted as functioning in accordance with IEEE 802.11 wireless networking standards.

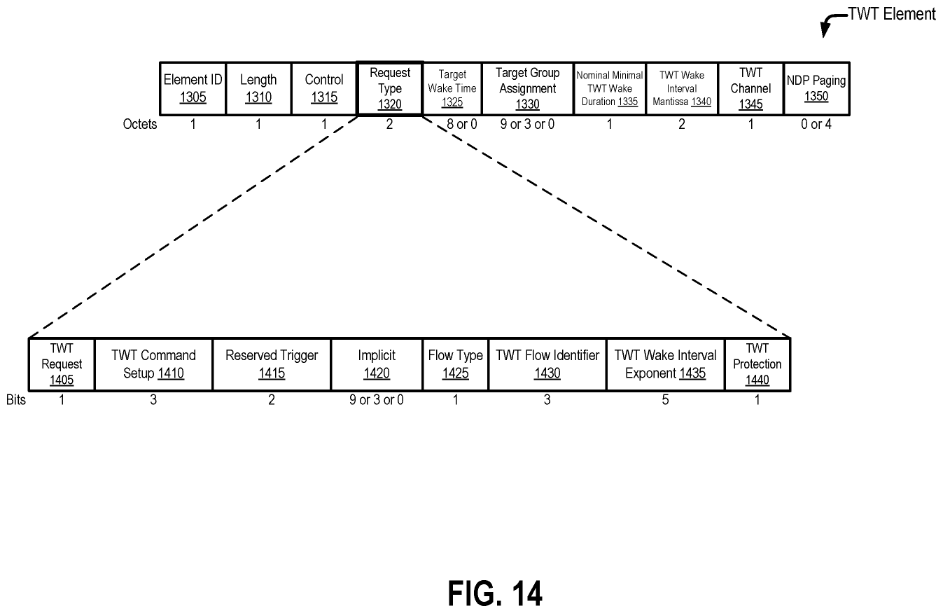

FIG. 14 is a diagram showing details of a request type field of a TWT element, according to some embodiments.

As mentioned earlier herein, the TWT element may include a request type field 1320. As shown in the diagram, the request type field 1320 may include a TWT request field 1405 (1 bit), a TWT command setup field 1410 (3 bits), a reserved trigger field 1415 (2 bits), an implicit field 1420 (9 or 3 or 0 bits), a flow type field 1425 (1 bit), a TWT flow identifier field (1430), a TWT wake interval exponent field 1435 (5 bits), and a TWT protection field 1440 (1 bit).

A STA may initiate a TWT negotiation process by transmitting a TWT negotiation request that includes a TWT element to the AP. Once the agreement is finalized, the STA may periodically wake up (enter the awakes state) according to the predefined wake intervals to communicate with the AP. The time interval between two consecutive wake-up instances may be defined by the TWT wake interval mantissa field 1340 of the TWT element and the TWT wake interval exponent field 1435 included in the request type field 1320 of the TWT element. Together, these fields may specify the exact timing for scheduled wake-up periods (SPs), allowing efficient coordination between the STA and the AP.

In addition to supporting long-term or scheduled power saving schemes such as TWT, it is expected that future wireless networking standards (e.g., the IEEE 802.11bn (UHR) wireless networking standard) may also support short-term or dynamic power saving schemes such as DPS to further improve energy efficiency and adapt to dynamic network conditions. Dynamic power saving schemes may allow STAs to dynamically adjust their power consumption behavior based on immediate operational needs.

DPS is one example of a short-term/dynamic power saving scheme. DPS allows a STA to dynamically transition between operating in a high capability (HC) mode and a low capability (LC) mode. The mode transitions may be controlled through control-level signaling, allowing the STA to reduce power consumption without significantly disrupting network performance. By alternating between the HC and LC modes, the STA may conserve power during periods of low activity while maintaining full operational capacity when needed.

Cross-link power saving (PS) is another example of a short-term/dynamic power saving scheme. Cross-link PS is designed for multi-link devices (MLDs). Cross-link PS may grant STA MLDs the flexibility to enable or disable power saving mode for individual links, ensuring efficient power management across multiple connections. Also, the STA MLD may report the power-saving status of its links to its associated AP MLD using a single active link to reduce unnecessary power consumption while maintaining network coordination.

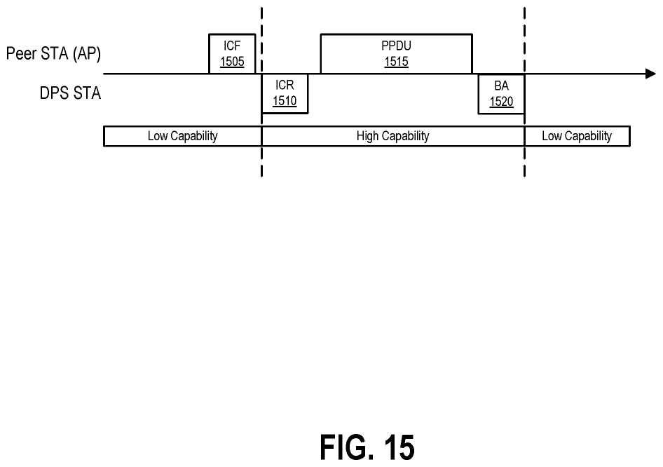

FIG. 15 is a diagram showing DPS operations, according to some embodiments.

DPS may allow a STA to dynamically alternate between operating in the LC mode and the HC mode, as needed. DPS is designed to optimize energy efficiency by allowing a STA to remain in the LC mode until higher transmission capacity is required. When DPS is enabled, a STA may operate in the LC mode to conserve power. When a peer STA such as an AP needs to initiate a frame exchange or transmission opportunity (TXOP), it may transmit an initial control frame (ICF) 1505 to the DPS-enabled STA to cause the STA to transition from operating in the LC mode to operating in the HC mode. The initial control frame 1505 serves to instruct the DPS-enabled STA to switch modes to support a higher data transmission rate.

Upon receiving the initial control frame 1505, the DPS-enabled STA may respond by transmitting an initial control response frame 1510 (ICR) to confirm that it has transitioned (or will transition) to operating in the HC mode. The initial control frame 1505 may include padding to ensure that the DPS-enabled STA has sufficient time to transition to operating in the HC mode. Since the DPS-enabled STA needs to successfully interpret the initial control frame 1505 before making the transition, an intermediate frame check sequence (FCS) field may be included in the initial control frame 1510 before the padding. This intermediate FCS field may allow the DPS-enabled STA to verify the initial control frame's 1505 integrity early and start the mode transition early.

Once the DPS-enabled STA finishes transitioning to operating in the HC mode, it can operate at full capacity for data transmission and reception. For example, as shown in the diagram, while the DPS-enabled STA operates in the HC mode, the AP may transmit PPDU 1515 to the DPS-enabled STA and the DPS-enabled STA may respond by transmitting block ACK frame 1520 to the AP. After the frame exchange ends, the DPS-enabled STA may transition back to operating in the LC mode to conserve power until another high capacity transmission is needed.

The present disclosure describes several types of SPs that leverage DPS features in different ways to support different power-saving needs/requirements. In an embodiment, a unified framework that integrates TWT and DPS features may define three types of SPs: a HC-only SP type, a DPS-allowed SP type, and a hybrid SP type. With a HC-only SP type, a STA that belongs to the SP operates in the HC mode for the entire duration of the SP. With a DPS-allowed SP type, a STA that belongs to the SP initially operates in the LC mode at the beginning of the SP and only transitions to operating in the HC mode when triggered by the AP. With a hybrid SP type, a STA that belongs to the SP initially operates in the HC mode at the beginning of the SP and transitions to operating in the LC mode when a predefined condition has been satisfied. The AP and the STA may negotiate the SP type of SPs in advance. Being able to negotiate the SP type may allow for adapting the STA behavior to optimize different operational aspects of the wireless network such as energy efficiency, latency, performance, and/or compatibility.

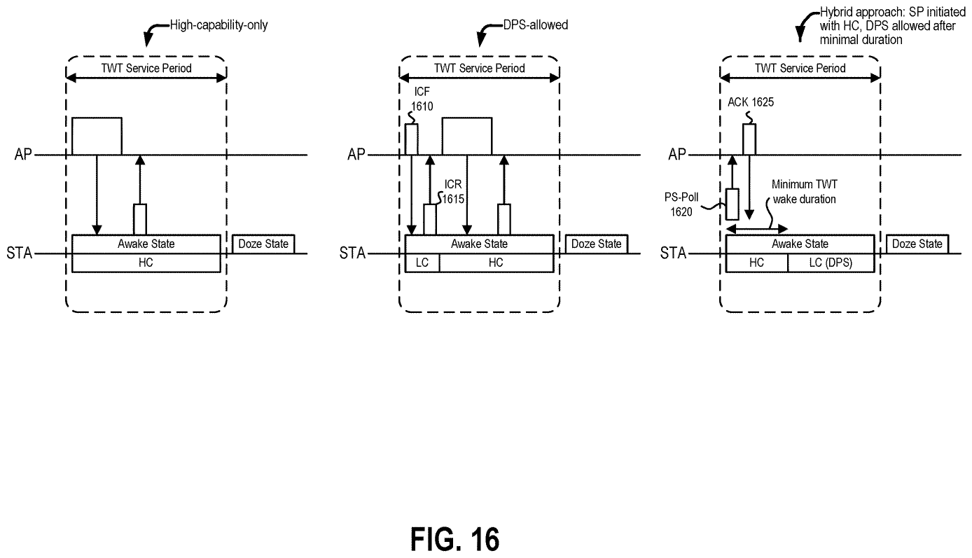

FIG. 16 is a diagram showing three SP types that integrate DPS features, according to some embodiments.

The three SP types shown in the diagram are: 1) the HC-only SP type; 2) the DPS-allowed SP type; and 3) the hybrid SP type.

With the HC-only SP type, as shown in the diagram, a STA that is a member of the SP operates in the HC mode for the entire TWT wake duration of the SP similar to traditional DPS-disabled STAs. The STA may enter a doze state when the SP ends. This SP type maintains compatibility with traditional DPS-disabled STAs and enables low latency transmission. Also, this SP type has low overhead because there is no need for exchanging control frames for DPS transitions (e.g., initial control frame and initial control response frames), making it particularly suitable for scenarios where low latency communication is a priority.

With the DPS-allowed SP type, as shown in the diagram, a STA that is a member of the SP initially operates in the LC mode at the beginning of the SP and only transitions to operating in the HC mode when triggered by the AP. The STA may enter a doze state when the SP ends. The AP may trigger the STA to transition to the HC mode by transmitting an initial control frame 1610 to the STA. Responsive to receiving the initial control frame 1610, the STA may transmit an initial control response frame 1615 to the AP to confirm that it has transitioned modes (or will transition modes). After the STA has transitioned to operating in the HC mode, the AP and the STA may perform a frame exchange. This SP type leverages DPS features to reduce power consumption while maintaining scheduled communications.

With the hybrid SP type, as shown in the diagram, a STA that is a member of the SP initially operates in the HC mode at the beginning of the SP and transitions to operating in the LC mode when a predefined condition has been satisfied. The STA may enter a doze state when the SP ends. In an embodiment, the predefined condition is that the minimum TWT wake duration has expired. For example, as shown in the diagram, the STA may initially operate in the HC mode at the beginning of the SP to ensure full operational capability for initial data frame exchanges. While operating in the HC mode, the STA may transmit a PS-Poll frame 1620 to the AP and the AP may respond by transmitting an ACK frame 1625 to the STA. After the STA has been operating in the HC mode for the minimum TWT wake duration, the STA may transition to operating in the LC mode to conserve power (instead of directly entering the doze state). Operating in the LC mode instead of entering the doze state allows for potentially extending active communications beyond the minimum TWT wake duration or other conditions such as SP early termination.

The different SP types may leverage DPS features in different ways to optimize different aspects of operational efficiency. The unified framework may allow for choosing between the different approaches based on the operational needs, for example, to optimize for power savings, network performance, responsiveness/latency, and/or compatibility.

The unified framework disclosed herein may integrate DPS features with TWT features to improve energy efficiency and provide operational flexibility in next-generation wireless networks (e.g., wireless networks supporting UHR features). For example, the unified framework may allow STAs to operate within a TWT SP using a combination of a DPS HC mode and a DPS LC mode. For example, a STA may operate in the HC mode at the beginning of the SP to process latency-sensitive communication and, after a minimum wake duration expires or upon the occurrence of specific condition(s) (e.g., SP early termination), the STA may transition to operating in the LC mode instead of entering the doze state. Such hybrid approach improves power efficiency without sacrificing responsiveness or compatibility.

Also, the unified framework may define and support different TWT SP types. For example, the framework may define and support a HC-only SP type, a DPS-allowed SP type, and a hybrid SP type. Having different types of SPs enables fine-grained control of STA behavior during SPs to adapt to the operational needs of the wireless network. For example, different SP types may be selected to optimize different aspects of wireless network operation such as throughput, latency, latency/responsiveness, and/or compatibility.

The unified framework may provide a way to negotiate the SP type during the TWT negotiation process. For example, to ensure coordinated operation between an AP and a STA, the SP type may be explicitly indicated in a TWT element during the TWT negotiation process. This allows the AP and STA to agree in advance on the operational behavior within upcoming SPs, which avoids ambiguity and ensures proper coordination between the AP and STA.

The unified framework is not limited to being applied in standard TWT scenarios but can also be applied in restricted TWT (r-TWT) and cooperative r-TWT scenarios. For example, the unified framework may be applied in these scenarios to provide hybrid power behavior during SPs, to support different SP types, and to enable SP type negotiation signaling. Thus, the unified framework is flexible and interoperable with different types of TWT schemes, and can improve energy efficiency and SP scheduling even in more complex and collaborative scheduling environments.

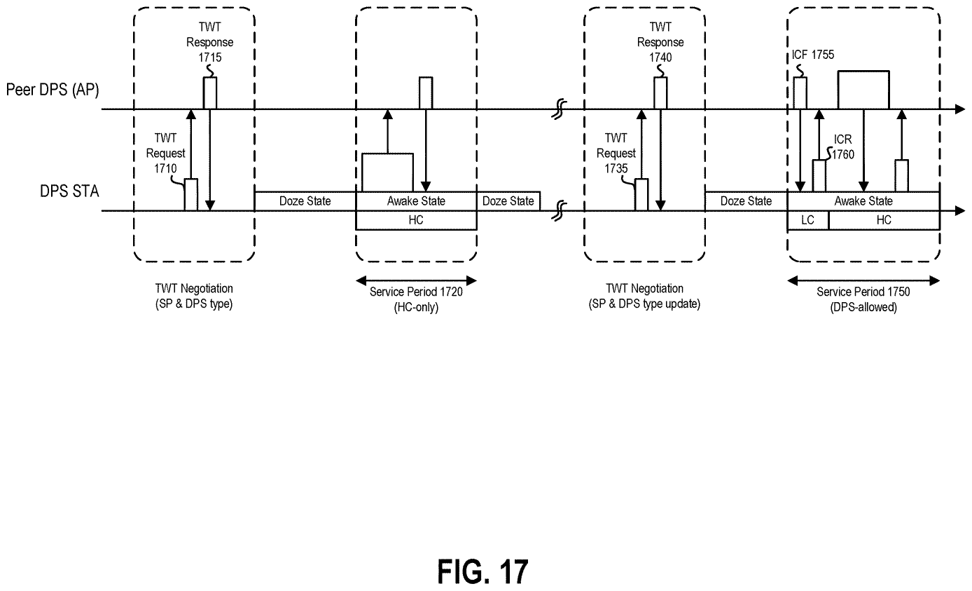

FIG. 17 is a diagram showing a frame exchange sequence for implementing a unified framework that integrates DPS features and TWT features, according to some embodiments.

As shown in the diagram, a DPS-enabled STA may transmit TWT request frame 1710 to the AP and the AP may respond by transmitting TWT response frame 1715. During this frame exchange, the AP and the STA may negotiate various parameters for upcoming SPs such as the timing of the SPs and the DPS configuration for the SPs. In this example, it is assumed that the negotiation results in the scheduling of SP 1720 having a HC-only SP type. Thus, the STA operates in the HC mode for the entire duration of SP 1720 and can exchange frames with the AP during SP 1720. The STA may enter the doze state when SP 1720 ends.

The TWT parameters can be dynamically updated based on the changing needs of the DPS-enabled STA. This means that if the STA's power-saving needs or traffic processing needs change, it can initiate a new negotiation session to modify the SP timing and/or the DPS configuration for subsequent SPs. For example, as shown in the diagram, the STA may initiate another TWT negotiation process by transmitting TWT request frame 1735 to the AP and the AP may respond by transmitting TWT response 1740. During this frame exchange, the AP and the STA may renegotiate parameters for upcoming SPs. In this example, it is assumed that the negotiation results in the scheduling of SP 1750 having a DPS-allowed SP type. Thus, the STA may initially operate in the LC mode at the beginning of SP 1750. While the STA is operating in the LC mode, the AP may transmit initial control frame 1755 to the STA to trigger the STA to transition to the HC mode. The STA may transmit initial control response frame 1760 to the AP to confirm the transition. The STA may then exchange frames with the AP while operating in the HC mode. The STA may enter the doze state when SP 1750 ends.

Thus, the unified framework may provide a flexible and adaptable power management approach that allows STAs to dynamically transition between the HC and LC modes based on the negotiated parameters to improve energy efficiency and/or network responsiveness.

As mentioned earlier, the unified framework may define and support different types of SPs that leverage DPS features in different ways and also allow the SP type to be negotiated. This enables fine-grained control over STA behavior during SPs. For example, the unified framework may define and support a HC-only SP type, a DPS-allowed SP type, and a hybrid SP type, as described earlier herein. Each SP type may support different operational goals, offering a configurable tradeoff between throughput, latency, and power savings.

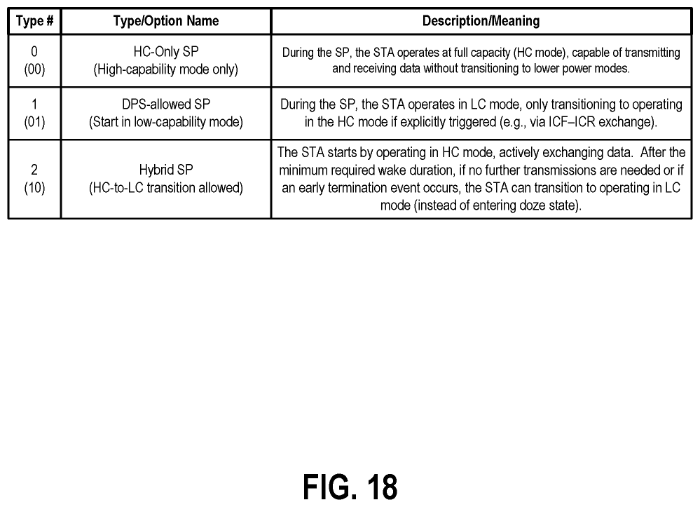

FIG. 18 is a diagram showing a table describing different types of SPs, according to some embodiments.

The table describes three types of SPs. The first type of SP is a HC-only SP type. With this type of SP, the STA operates at full capacity (in the HC mode) during the entire duration of the SP (e.g., does not transition to the LC mode or enter the doze state during the SP). This SP type is designed to ensure maximum performance and minimal communication latency, making it suitable for real-time or low-latency applications, as well as for maintaining compatibility with legacy STAs that do not support DPS.

The second type of SP is a DPS-allowed SP type. With this type of SP, the STA initially operates in the LC mode at the beginning of the SP (starts by operating in the LC mode) and only transitions to operating in the HC mode if it is explicitly triggered (e.g., via an initial control frame and initial control response frame exchange). This SP type is designed to conserve power, making it suitable for energy-sensitive applications such as IoT or background tasks, where latency is less critical and power conservation is the priority.

The third type of SP is a hybrid SP type. With this type of SP, the STA initially operates in the HC mode at the beginning of the SP and actively exchanges data. After the minimum required wake duration has expired, if no further transmissions are needed or if a SP early termination event occurs, the STA may transition to operating in the LC mode (instead of entering the doze state) (HC-to-LC mode transition allowed).

The AP and the STA may negotiate the SP type during the TWT negotiation process. This allows both the AP and the STA to coordinate their behaviors in advance. The SP type may be indicated in a TWT element during the TWT negotiation process.

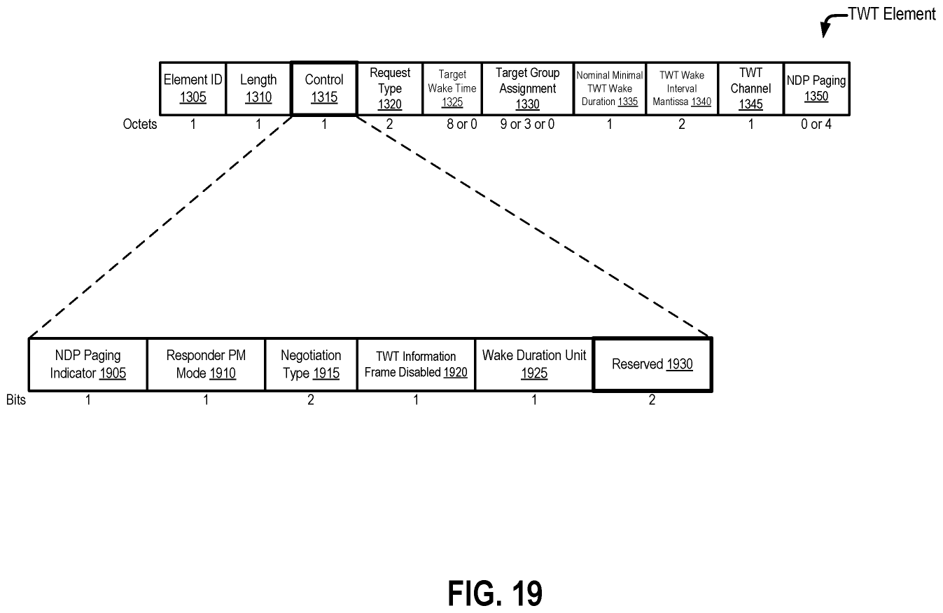

FIG. 19 is a diagram showing a format of a control field of a TWT element, according to some embodiments.

As mentioned earlier, a TWT element may include a control field 1315. The control field 1315 may be used to support various TWT operation modes such as individual TWT, broadcast TWT, and opportunistic power save (OPS). As shown in the diagram, the control field 1315 may include a NDP paging indicator field 1905 (1 bit), a responder power management (PM) mode field 1910 (1 bit), a negotiation type field 1915 (2 bits), a TWT information frame disabled field 1920 (1 bit), a wake duration unit field 1925 (1 bit), and a reserved field 1930 (2 bits).

In an embodiment, the control field 1315 can be configured to support the negotiation of SP types mentioned earlier herein (e.g., the SP types shown in FIG. 18). For example, two bits within the reserved field 1930 may be allocated to specify the SP type. This enables the AP and the STA to explicitly exchange DPS-related capabilities and behavioral intent during the TWT negotiation process.

In an embodiment, the SP type is encoded using two bits as follows. For example, a value of binary “00” may indicate the HC-only SP type, a value of binary “01” may indicate the DPS-allowed SP type, and a value of binary “10” may indicate the hybrid SP type. Such encoding may allow for an efficient and scalable SP type negotiation while maintaining backward compatibility and providing room for future extension. Through negotiation, the DPS configuration can be changed on a per-SP basis. While a particular SP type encoding is described herein, it will be appreciated that the SP type can be encoded in other ways.

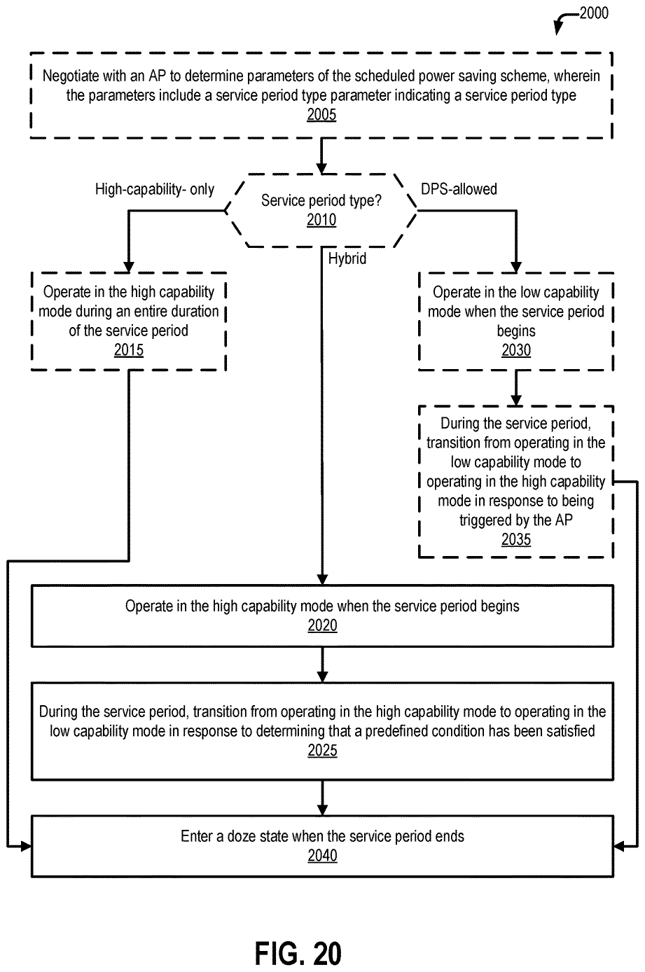

Turning now to FIG. 20, a method 2000 will be described for integrating a dynamic power saving scheme with a scheduled power saving scheme, in accordance with an example embodiment. The method 2000 may be performed by a STA. The STA may be implemented by a wireless device (e.g., wireless device 104).

In an embodiment, at operation 2005, the STA negotiates with an AP to determine parameters of the scheduled power saving scheme, wherein the parameters include a service period type parameter indicating a service period type. In an embodiment, the negotiating with the AP comprises transmitting a request message to the AP and receiving a response message from the AP, wherein the response message includes a control field (e.g., control field 1315) that carries the service period type parameter. In an embodiment, the control field encodes the service period type parameter using two bits.

In an embodiment, at operation 2010, the STA determines whether the service period type is a high-capability-only service period type, a DPS-allowed service period type, or a hybrid service period type.

If the service period type is high-capability-only, the method may proceed to operation 2015. At operation 2015, the STA operates in the high capability mode during an entire duration of the service period. The method may then proceed to operation 2040, at which the STA enters the doze state when the service period ends.

If the service period type is DPS-allowed, the method may proceed to operation 2030. At operation 2030, the STA operates in the low capability mode when the service period begins. At operation 2035, during the service period, the STA transitions from operating in the low capability mode to operating in the high capability mode in response to being triggered by the AP. The method may then proceed to operation 2040, at which the STA enters the doze state when the service period ends.

If the service period type is hybrid, the method may proceed to operation 2020. At operation 2020, the STA operates in the high capability mode when the service period begins. At operation 2025, during the service period, the STA transitions from operating in the high capability mode to operating in the low capability mode in response to determining that a predefined condition has been satisfied. The method may then proceed to operation 2040, at which the STA enters the doze state when the service period ends. In an embodiment, the predefined condition is that the STA has been operating in the high capability mode for a predefined duration. In an embodiment, this predefined duration is a minimum wake duration that is negotiated with an AP. In an alternate embodiment, the predefined condition is early termination of the service period.

In an embodiment, the STA negotiates with an AP to determine parameters of the scheduled power saving scheme, wherein the parameters include a service period type parameter indicating that a second service period is a high-capability-only type service period. The STA may then operate in the high capability mode during an entire duration of the second service period.

In an embodiment, the STA negotiates with an AP to determine parameters of the scheduled power saving scheme, wherein the parameters include an updated service period type parameter indicating that a second service period is a dynamic-power-saving-allowed (DPS-allowed) type service period. The STA may then operate in the low capability mode when the second service period begins. During the second service period, the STA may transition from operating in the low capability mode to operating in the high capability mode in response to being triggered by the AP. In an embodiment, the being triggered by the AP comprises receiving an initial control frame (ICF) from the AP.

In an embodiment, the scheduled power saving scheme is a TWT scheme and/or the dynamic power saving scheme is DPS scheme.

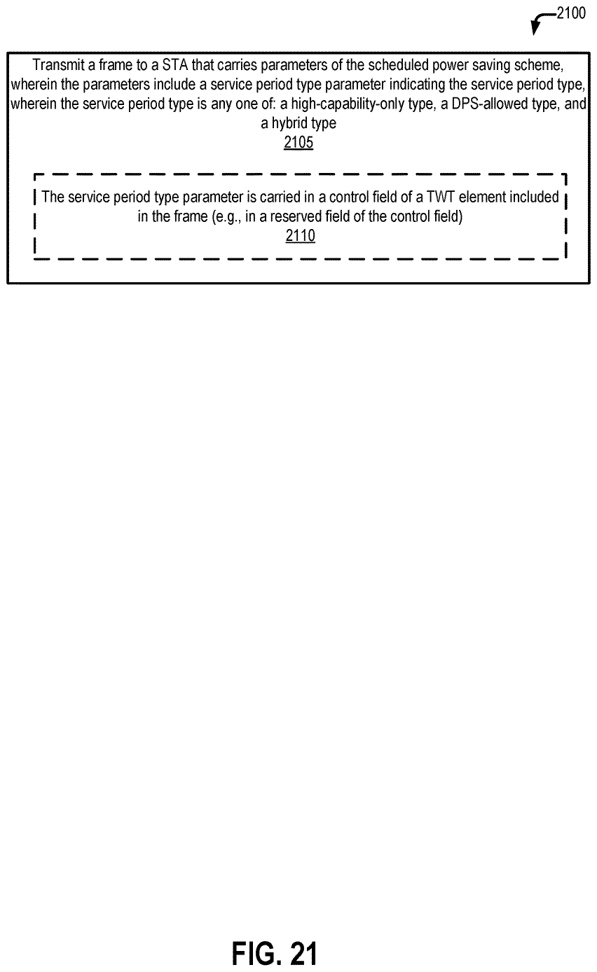

Turning now to FIG. 21, a method 2100 will be described for indicating a service period type, in accordance with an example embodiment. The method 2100 may be performed by an AP. The AP may be implemented by a wireless device (e.g., wireless device 104).

At operation 2105, the AP transmits a frame to a STA that carries parameters of the scheduled power saving scheme (e.g., as part of TWT negotiation process), wherein the parameters include a service period type parameter indicating the service period type, wherein the service period type is any one of: a high-capability-only type, a DPS-allowed type, and a hybrid type. In an embodiment, as shown in block 2110, the service period type parameter is carried in a control field (e.g., control field 1315) of a TWT element included in the frame (e.g., in a reserved field of the control field). In an embodiment, the control field encodes the service period type parameter using two bits.

Although many of the solutions and techniques provided herein have been described with reference to a WLAN system, it should be understood that these solutions and techniques are also applicable to other network environments, such as cellular telecommunication networks, wired networks, etc. In some embodiments, the solutions and techniques provided herein may be or may be embodied in an article of manufacture in which a non-transitory machine-readable medium (such as microelectronic memory) has stored thereon instructions which program one or more data processing components (generically referred to here as a “processor” or “processing unit”) to perform the operations described herein. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

In some cases, an embodiment may be an apparatus (e.g., an AP STA, a non-AP STA, or another network or computing device) that includes one or more hardware and software logic structures for performing one or more of the operations described herein. For example, as described herein, an apparatus may include a memory unit, which stores instructions that may be executed by a hardware processor installed in the apparatus. The apparatus may also include one or more other hardware or software elements, including a network interface, a display device, etc.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system may carry out the computer-implemented methods described herein in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method performed by a station (STA) to integrate a scheduled power saving scheme with a dynamic power saving scheme, the method comprising:
operating in a high capability mode of the dynamic power saving scheme when a service period of the scheduled power saving scheme begins;
during the service period, transitioning from operating in the high capability mode to operating in a low capability mode of the dynamic power saving scheme in response to determining that a predefined condition has been satisfied; and
entering a doze state when the service period ends.

2. The method of claim 1, further comprising:
negotiating with an access point (AP) to determine parameters of the scheduled power saving scheme, wherein the parameters include a service period type parameter indicating that the service period is a hybrid type service period.

3. The method of claim 2, wherein the negotiating with the AP comprises transmitting a request message to the AP and receiving a response message from the AP, wherein the response message includes a control field that carries the service period type parameter.

4. The method of claim 3, wherein the control field encodes the service period type parameter using two bits.

5. The method of claim 1, wherein the predefined condition is that the STA has been operating in the high capability mode for a predefined duration.

6. The method of claim 5, wherein the predefined duration is a minimum wake duration that is negotiated with an access point (AP).

7. The method of claim 1, wherein the predefined condition is early termination of the service period.

8. The method of claim 1, further comprising:
negotiating with an access point (AP) to determine parameters of the scheduled power saving scheme, wherein the parameters include a service period type parameter indicating that a second service period is a high-capability-only type service period; and
operating in the high capability mode during an entire duration of the second service period.

9. The method of claim 1, further comprising:
negotiating with an access point (AP) to determine parameters of the scheduled power saving scheme, wherein the parameters include an updated service period type parameter indicating that a second service period is a dynamic-power-saving-allowed type service period;
operating in the low capability mode when the second service period begins; and
during the second service period, transitioning from operating in the low capability mode to operating in the high capability mode in response to being triggered by the AP.

10. The method of claim 9, wherein the being triggered by the AP comprises receiving an initial control frame (ICF) from the AP.

11. The method of claim 1, wherein the scheduled power saving scheme is a target wake time (TWT) scheme.

12. A wireless device configured to implement a station (STA), the wireless device comprising:
a radio frequency transceiver;
a memory device storing a set of instructions; and
a processor coupled to the memory device, wherein the set of instructions, when executed by the processor, causes the STA to:
operate in a high capability mode of a dynamic power saving scheme when a service period of a scheduled power saving scheme begins;
during the service period, transition from operating in the high capability mode to operating in a low capability mode of the dynamic power saving scheme in response to determining that a predefined condition has been satisfied; and
enter a doze state when the service period ends.

13. The wireless device of claim 12, wherein the set of instructions, when executed by the processor, further causes the STA to:
negotiate with an access point (AP) to determine parameters of the scheduled power saving scheme, wherein the parameters include a service period type parameter indicating that the service period is a hybrid type service period.

14. The wireless device of claim 13, wherein the negotiating with the AP comprises transmitting a request message to the AP and receiving a response message from the AP, wherein the response message includes a control field that carries the service period type parameter.

15. The wireless device of claim 14, wherein the control field encodes the service period type parameter using two bits.

16. The wireless device of claim 12, wherein the predefined condition is that the STA has been operating in the high capability mode for a predefined duration.

17. The wireless device of claim 16, wherein the predefined duration is a minimum wake duration that is negotiated with an access point (AP).

18. The wireless device of claim 12, wherein the predefined condition is early termination of the service period.

19. The wireless device of claim 12, wherein the set of instructions, when executed by the processor, further causes the STA to:
negotiate with an access point (AP) to determine parameters of the scheduled power saving scheme, wherein the parameters include a service period type parameter indicating that a second service period is a high-capability-only type service period; and
operate in the high capability mode during an entire duration of the second service period.

20. The wireless device of claim 12, wherein the set of instructions, when executed by the processor, further causes the STA to:
negotiate with an access point (AP) to determine parameters of the scheduled power saving scheme, wherein the parameters include an updated service period type parameter indicating that a second service period is a dynamic-power-saving-allowed type service period;
operate in the low capability mode when the second service period begins; and
during the second service period, transition from operating in the low capability mode to operating in the high capability mode in response to being triggered by the AP.

21. The wireless device of claim 20, wherein the being triggered by the AP comprises receiving an initial control frame (ICF) from the AP.

22. The wireless device of claim 12, wherein the scheduled power saving scheme is a target wake time (TWT) scheme.
